(19) United States
(12) Patent Application Publication
(10) Pub. No.: US 2023/0213846 A1
(43) Pub. Date: Jul. 6, 2023

(54) LIGHTING MODULE AND PROJECTION DEVICE

(71) Applicant: Coretronic Corporation, Hsin-Chu (TW)

(72) Inventor: Pi-Tsung Hsu, Hsin-Chu (TW)

(73) Assignee: Coretronic Corporation, Hsin-Chu (TW)

(21) Appl. No.: 18/150,205

(22) Filed: Jan. 5, 2023

(30) Foreign Application Priority Data
Jan. 6, 2022 (CN) 202220015841.X

(51) Int. Cl. G03B 21/20; G02B 26/00; G03B 21/16

(52) U.S. Cl. CPC G03B 21/204; G02B 26/007; G03B 21/16

(57) ABSTRACT

A lighting module is configured to provide a lighting beam and includes a light source providing an excitation beam, a rotating wheel module disposed on a transmission path of the excitation beam, and a first airflow generator. The rotating wheel module includes driving blades disposed at an interval. Any two adjacent driving blades form an airflow channel. The first airflow generator generates a first airflow that flows through the airflow channels of the driving blades to drive the rotating wheel module to rotate. At least a part of the light source is disposed on a flow path of the first airflow. With the foregoing design, the rotating wheel module can be passively rotated by the first airflow without a driver. Since a driver is omitted, the lighting module has a smaller size and greater design flexibility, and the rotating wheel module also has a larger usable area.

### CROSS-REFERENCE TO RELATED APPLICATION

This application claims the priority benefit of China application serial no. 202220015841.X filed on Jan. 6, 2022. The entirety of the above-mentioned patent application is hereby incorporated by reference herein and made a part of this specification.

### BACKGROUND

### Technical Field

The present invention relates to an optical module and an optical device, and particularly relates to a lighting module and a projection device.

### Description of Related Art

In a general projection device, a rotating wheel (such as a phosphor wheel, a diffusion wheel or a color wheel) is driven by a driver (such as a motor) to rotate. However, the arrangement of the driver makes it difficult to miniaturize the size of the projection device. In addition, the driver occupies most of the usable area of the rotating wheel, reducing the usable area of the surface of the rotating wheel. The combination of a rotating wheel and a driver also affects the design flexibility of the rotating wheel structure.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The present invention provides a lighting module and a projection device, which reduce the volume of a rotating wheel module and increase the usable area of a surface of the rotating wheel module.

Other objectives and advantages of the present invention can be further understood from the technical features disclosed in the present invention.

In order to achieve one of, a part of, or all of the above objectives or other objectives, an embodiment of the present invention provides a lighting module configured to provide a lighting beam. The lighting module includes a light source, a rotating wheel module, and a first airflow generator. The light source is configured to provide an excitation beam. The rotating wheel module is disposed on a transmission path of the excitation beam, and the rotating wheel module includes multiple driving blades, in which the driving blades are disposed at an interval and any two adjacent driving blades form an airflow channel. The first airflow generator is configured to generate a first airflow, and the first airflow flows through the airflow channels of the driving blades to drive the rotating wheel module to rotate, in which at least a part of the light source is disposed on a flow path of the first airflow.

In order to achieve one of, a part of, or all of the above objectives or other objectives, an embodiment of the present invention provides a projection device including the lighting module, a light valve assembly, and a projection lens. The light valve assembly is disposed on a transmission path of the lighting beam, and is configured to convert the lighting beam into an image beam. The projection lens is configured to project the image beam out of the projection device.

In an embodiment of the present invention, the first airflow generator is a fan, and includes multiple first fan blades and a first driving shaft, in which an orthographic projection of the driving blades on a reference plane perpendicular to the first driving shaft at least partially overlaps an orthographic projection of the first fan blades on the reference plane.

In an embodiment of the present invention, an orthographic projection of the light source on the reference plane of the first airflow generator at least partially overlaps the orthographic projection of the first fan blades on the reference plane.

In an embodiment of the present invention, the lighting module further includes a second airflow generator configured to generate a second airflow, in which the second airflow flows through the airflow channels of the driving blades to drive the rotating wheel module to rotate.

In an embodiment of the present invention, the rotating wheel module further includes a first rotating wheel and a second rotating wheel, in which the driving blades are disposed on the first rotating wheel and the second rotating wheel.

In an embodiment of the present invention, the rotating wheel module further includes a base plate, in which the base plate includes a first disc body and a second disc body. The first disc body is coaxial with the second disc body and spaced apart from the second disc body, in which the driving blades are located between the first disc body and the second disc body.

In an embodiment of the present invention, the rotating wheel module further includes a first passive rotating shaft, and the first airflow generator includes a first driving shaft, in which the first passive rotating shaft is perpendicular to the first driving shaft, in which the rotating wheel module is not connected to the first airflow generator.

In an embodiment of the present invention, the rotating wheel module further includes a base plate and an optical element connected to the base plate.

In an embodiment of the present invention, the base plate includes a light-transmitting glass or a reflective metal layer.

In an embodiment of the present invention, the optical element includes at least one wavelength conversion layer or a light diffusing layer.

In an embodiment of the present invention, the driving blades are disposed on the base plate.

In an embodiment of the present invention, the lighting module further includes a second airflow generator configured to generate a second airflow, in which the base plate further includes a first disc body and a first passive rotating shaft, and the second airflow generator includes a second driving shaft. The driving blades are obliquely disposed on the first disc body, in which the first passive rotating shaft is perpendicular to the first disc body, and the first passive rotating shaft is parallel to the second driving shaft.

In an embodiment of the present invention, the base plate further includes a second disc body coaxial with the first disc body and spaced apart from the first disc body, and the second disc body is disposed between the first disc body and the second airflow generator. The driving blades are located between the first disc body and the second disc body, in which the second disc body includes at least one opening, the at least one opening connects the airflow channels, and the second airflow enters the airflow channels of the rotating wheel module from the at least one opening and drives the driving blades.

In an embodiment of the present invention, the rotating wheel module includes a first rotating wheel, a slide rail, and a sliding block slidably disposed on the slide rail. The first rotating wheel includes a first passive rotating shaft, and the driving blades are disposed on the first rotating wheel, in which the first passive rotating shaft is pivotally connected to the slide rail. The first airflow generator includes a first driving shaft, in which the first driving shaft is perpendicular to the first passive rotating shaft, and an extension direction of the slide rail is parallel to the first driving shaft.

In an embodiment of the present invention, the sliding block includes an optical element.

In an embodiment of the present invention, the rotating wheel module further includes a second rotating wheel, in which the second rotating wheel includes a second passive rotating shaft, in which the second passive rotating shaft is pivotally connected to the sliding block. The second passive rotating shaft is perpendicular to the first passive rotating shaft and perpendicular to the first driving shaft, in which the second rotating wheel includes an optical element.

Based on the above, the embodiments of the present invention have at least one of the following advantages or effects. The first airflow generated by the first airflow generator of the lighting module of the present invention flows through the airflow channel and drives the driving blades, which drive the rotating wheel module to rotate. With the foregoing design, the rotating wheel module of the present invention can be passively rotated by the first airflow, and a driver is not needed to rotate the rotating wheel module. Since the driver originally required is omitted from the lighting module, the lighting module of the present invention has a smaller size and greater design flexibility. In addition, the rotating wheel module also has a larger usable area.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWING

The accompanying drawings are included to provide a further understanding of the invention, and are incorporated in and constitute a part of this specification. The drawings illustrate examples of the invention and, together with the description, serve to explain the principles of the invention.

FIG. 1 is a schematic diagram of a projection device according to an embodiment of the present invention.

FIG. 2A is a schematic perspective view of the lighting module of the first embodiment.

FIG. 2B and FIG. 2C are a top view and a side view of the lighting module of FIG. 2A, respectively.

FIG. 3A is a schematic perspective view of the lighting module of the second embodiment.

FIG. 3B is a top view of the lighting module of FIG. 3A.

FIG. 4 is a schematic perspective view of a lighting module according to the third embodiment of the present invention.

FIG. 5A is a schematic perspective view of a lighting module according to the fourth embodiment.

FIG. 5B is a side view of the lighting module of FIG. 5A.

FIG. 6A is a schematic perspective view of a lighting module according to the fifth embodiment.

FIG. 6B and FIG. 6C are side views of the lighting module of FIG. 6A.

FIG. 7A is a schematic perspective view of a lighting module according to the sixth embodiment.

FIG. 7B is a top view of the lighting module of FIG. 7A.

FIG. 8A is a schematic perspective view of a lighting module according to the seventh embodiment.

FIG. 8B and FIG. 8C are a top view and a side view of the lighting module of FIG. 8A, respectively.

FIG. 9A and FIG. 9B are schematic views of a slide rail, a sliding block, and a first rotating wheel shown in FIG. 8A in different states.

FIG. 9C is a top view of the slide rail, the sliding block, and the first rotating wheel of FIG. 9A and FIG. 9B.

FIG. 10A is a schematic perspective view of a lighting module according to the eighth embodiment.

FIG. 10B is a side view of the lighting module of FIG. 10A.

### DETAILED DESCRIPTION OF DISCLOSED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

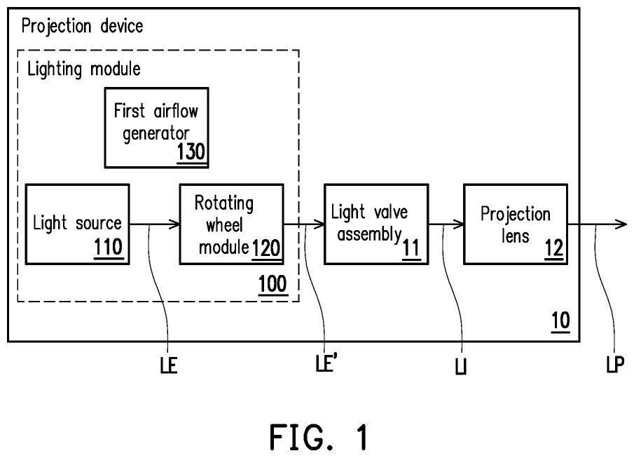

FIG. 1 is a schematic diagram of a projection device according to an embodiment of the present invention. Referring to FIG. 1, the projection device 10 of this embodiment includes a lighting module 100, a light valve assembly 11, and a projection lens 12. The lighting module 100 is configured to provide a lighting beam LE′. The lighting module 100 includes a light source 110 and a rotating wheel module 120. The light source 110 is configured to provide an excitation beam LE. The light source 110 is, for example, a solid-state illumination source, such as a light emitting diode or a laser diode. In this embodiment, the light source 110 is composed of, for example, multiple laser diodes arranged in an array.

The rotating wheel module 120 is disposed on the transmission path of the excitation beam LE. The rotating wheel module 120 is, for example, a phosphor wheel, a diffusion wheel, or a combination thereof. The excitation beam LE from the light source 110 is guided to the rotating wheel module 120 to form the lighting beam LE′.

The light valve assembly 11 is disposed on the transmission path of the lighting beam LE′ from the lighting module 100, and the lighting beam LE′ is guided to the light valve assembly 11 and is converted into an image beam LI by the light valve assembly 11. The light valve assembly 11 is, for example, a reflective light modulator such as a liquid crystal on silicon panel (LCoS panel) or a digital micro-mirror device (DMD). In some embodiments, the light valve assembly 11 may also be a transmissive light modulator, such as a transparent liquid crystal panel, an electro-optical modulator, a magneto-optic modulator, or an acousto-optic modulator (AOM).

The projection lens 12 is disposed on the transmission path of the image beam LI from the light valve assembly 11 and is configured to convert the image beam LI into a projection beam LP, which is then projected to a projection target (not shown), such as a screen or a wall. The projection lens 12 includes, for example, one optical lens or a combination of optical lenses with diopter, for example, various combinations of non-planar lenses such as biconcave lenses, biconvex lenses, concave-convex lenses, convex-concave lenses, plano-convex lenses, and/or plano-concave lenses. In some embodiments, the projection lens 12 may also include a flat mirror or a curved mirror, which converts the image beam LI from the light valve assembly 11 into a projection beam LP by reflection, and then projects the projection beam LP out of the projection device 10 to form a projection image on the projection target.

In this embodiment, the lighting module 100 has a special design, so that the lighting module 100 can have a smaller volume, which is described below.

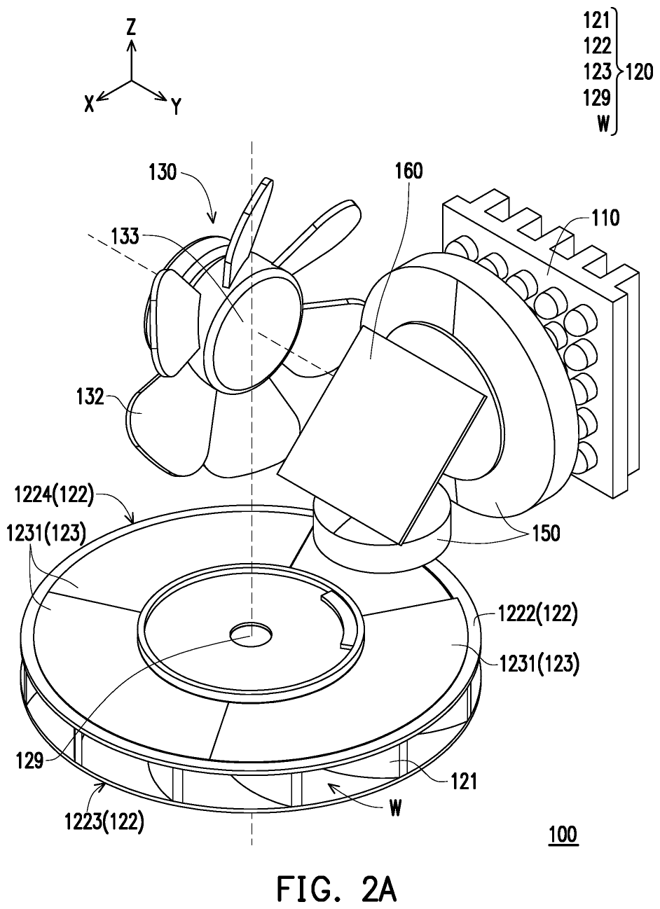

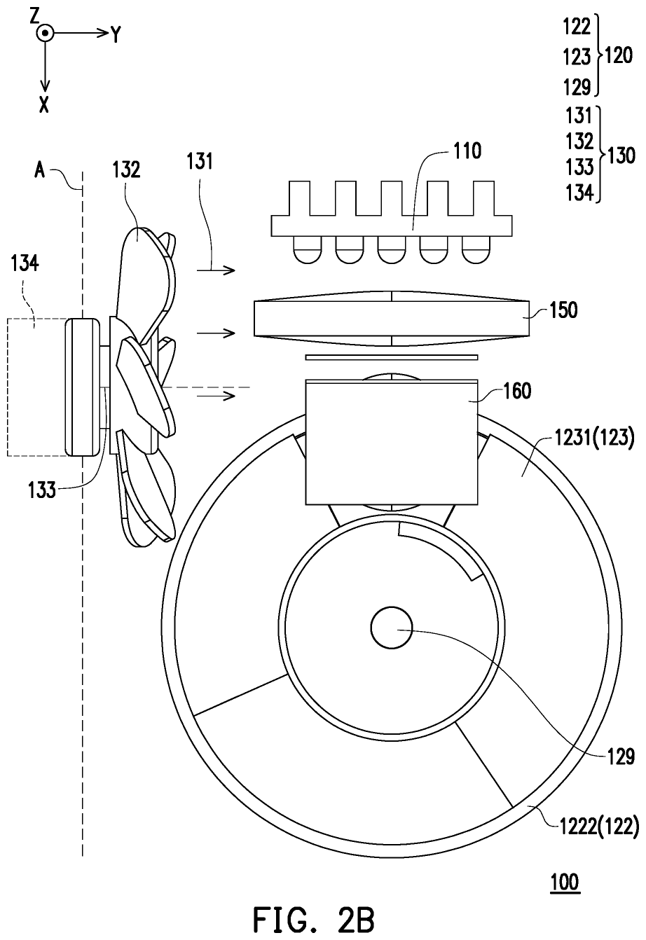

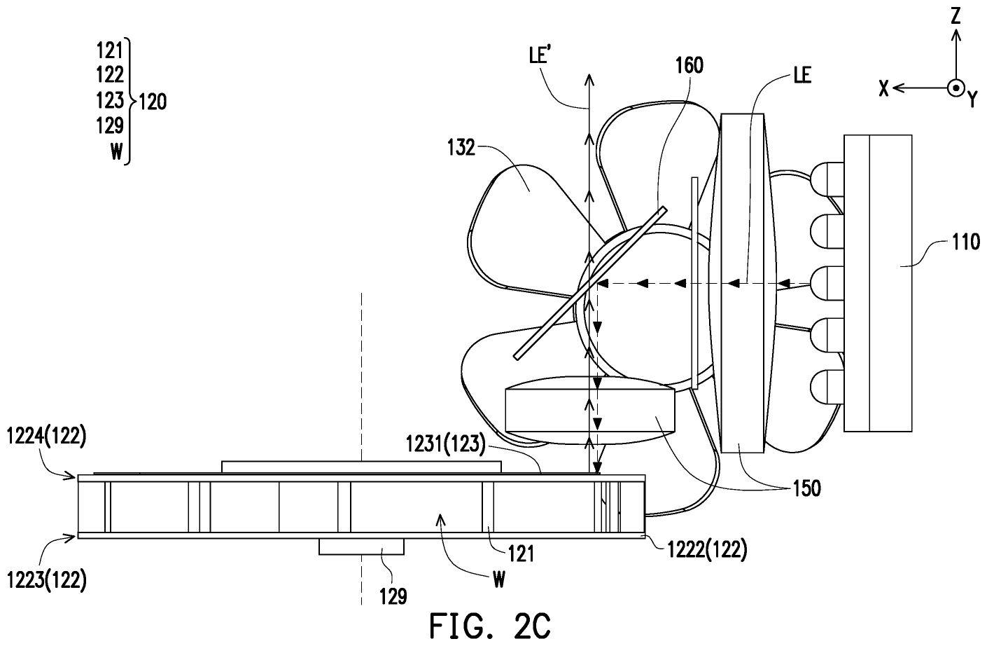

FIG. 2A is a schematic perspective view of the lighting module of the first embodiment. FIG. 2B and FIG. 2C are a top view and a side view of the lighting module of FIG. 2A, respectively. Referring to FIG. 2A to FIG. 2C, in this embodiment, the rotating wheel module 120 includes multiple driving blades 121, a base plate 122, and a first passive rotating shaft 129. The base plate 122 includes a first disc body 1223 and a second disc body 1224. The first disc body 1223 is coaxial with the second disc body 1224 and spaced apart from the second disc body 1224. The driving blades 121 are located between the first disc body 1223 and the second disc body 1224 and are spaced apart from each other, in which the driving blade 121 is, for example, an elongated plate, two opposite long sides of which are respectively connected to the first disc body 1223 and the second disc body 1224, and the driving blade 121 is, for example, perpendicular to the first disc body 1223 and the second disc body 1224, respectively. Any two adjacent driving blades 121 form an airflow channel W. In other embodiments, the first disc body 1223, the second disc body 1224, and the driving blade 121 may be independently disposed components or an integrally formed structure. Nevertheless, the present invention is not limited thereto.

The lighting module 100 further includes a first airflow generator 130. The rotating wheel module 120 is not connected to the first airflow generator 130. In this embodiment, the first airflow generator 130 is, for example, a fan or a blower. The first airflow generator 130 in this embodiment is, for example, a fan, and includes multiple first fan blades 132, a first driving shaft 133, and a motor 134 (shown in FIG. 2B). The motor 134 is connected to the first driving shaft 133 and drives the first fan blades 132 to rotate around the first driving shaft 133, to generate the first airflow 131 (shown in FIG. 2B). In this embodiment, the first passive rotating shaft 129 of the rotating wheel module 120 is perpendicular to the first driving shaft 133 of the first airflow generator 130. In other embodiments, the flow direction of the first airflow 131 in the airflow channel W is parallel to the base plate 122.

It should be noted that the first airflow generator 130 in other embodiments of the present invention also has a motor 134. In order to keep the figures concise, the motor 134 is not shown in the subsequent figures.

It is worth mentioning that, in this embodiment, the first airflow 131 generated by the first airflow generator 130 drives the driving blades 121 of the rotating wheel module 120 to drive the rotating wheel module 120 to rotate with the first passive rotating shaft 129 as the center. In addition, at least one part of the light source 110 is disposed on the flow path of the first airflow 131, so that the light source 110 can dissipate heat and cool down when providing the excitation beam LE. That is, the first airflow 131 generated by the first airflow generator 130 can not only drive the rotating wheel module 120 to rotate and but also cool down the light source 110 and the rotating wheel module 120.

Specifically, referring to FIG. 2B and FIG. 2C, there is a reference plane A (shown in FIG. 2B) perpendicular to the first driving shaft 133 on the XZ plane, and the orthographic projection of the driving blade 121 of the rotating wheel module 120 (shown in the FIG. 2C) on the reference plane A (shown in FIG. 2B) at least partially overlaps the orthographic projection of the first fan blade 132 on the reference plane A. In this embodiment, the orthographic projection of the driving blade 121 on the reference plane A perpendicular to the first driving shaft 133 partially overlaps the orthographic projection of the first fan blade 132 on the reference plane A. In other embodiments, the orthographic projection of the driving blade 121 on the reference plane A perpendicular to the first driving shaft 133 may also completely overlap the orthographic projection of the first fan blade 132 on the reference plane A.

Therefore, a part of the first airflow 131 (shown in FIG. 2B) generated by the first fan blade 132 flows through the airflow channel W between the driving blades 121, thereby driving the rotating wheel module 120 to rotate, and at the same time allowing the rotating wheel module 120 to dissipate heat and cool down.

In addition, the orthographic projection of the light source 110 on the reference plane A perpendicular to the first driving shaft 133 at least partially overlaps the orthographic projection of the first fan blade 132 on the reference plane A. In this embodiment, the orthographic projection of the light source 110 on the reference plane A partially overlaps the orthographic projection of the first fan blade 132 on the reference plane A. In other embodiments, the orthographic projection of the light source 110 on the reference plane A may also completely overlap the orthographic projection of the first fan blade 132 on the reference plane A. That is, at least a part of the light source 110 is disposed on the flow path of the first airflow 131. A part of the first airflow 131 generated by the first fan blade 132 flows toward the light source 110 to dissipate heat and cool down the light source 110.

In addition, as shown in FIG. 2C, the light source 110 outputs the excitation beam LE, and the color of the excitation beam LE is, for example, blue. The lighting module 100 further includes at least one condensing lens 150 and a light splitting element 160, in which the condensing lens 150 and the light splitting element 160 are located on the transmission path of the excitation beam LE. The excitation beam LE first passes through the condensing lens 150 and then enters the light splitting element 160. The light splitting element 160 is a dichroic mirror that separates colors by their wavelengths. The light splitting element 160 of this embodiment has the function of, for example, reflecting the blue beam and allowing the beams of other colors to pass through. Therefore, the blue excitation beam LE of the present embodiment is reflected by the light splitting element 160, passes through another condensing lens 150, and then is transmitted to the rotating wheel module 120.

In this embodiment, the rotating wheel module 120 is embodied as a reflective phosphor wheel, and a reflective metal layer 1222 is disposed on the second disc body 1224 of the base plate 122. The rotating wheel module 120 further includes an optical element 123 disposed on the reflective metal layer 1222. In this embodiment, the optical element 123 is, for example, a wavelength conversion layer 1231.

Referring to FIG. 2C, when the excitation beam LE is directed toward the rotating wheel module 120 that is rotating, the excitation beam LE enters the wavelength conversion layer 1231 on the rotating wheel module 120. The wavelength conversion layer 1231 can convert the excitation beam LE of the blue wavelength band into the lighting beam LE′ of other color wavelength bands, for example, a yellow or green lighting beam LE′. The lighting beam LE′ comprises at least one of the yellow beam, green beam and the excitation beam LE.

In addition, the rotating wheel module 120 of this embodiment has multiple wavelength conversion layers 1231, and the wavelengths converted by the wavelength conversion layers 1231 may be different. That is, a part of the rotating wheel module 120 enters the transmission path of the excitation beam LE in a timing sequence. During the rotation of the rotating wheel module 120, the excitation beam LE illuminates one of the different wavelength conversion layers 1231 in sequence, and the lighting beam LE′ of different colors is generated at different time points.

Since the rotating wheel module 120 of the present embodiment includes the reflective metal layer 1231, a lighting beam LE′ with a changed wavelength is reflected by the reflective metal layer 1222 and directed toward the light splitting element 160. Since the color of the lighting beam LE′ with the changed wavelength is no longer blue, the lighting beam LE′ with the changed wavelength can pass through the light splitting element 160 that only reflects blue wavelength, and then directed toward the light valve assembly 11 (shown in FIG. 1). In addition, in other embodiments, for example, part of the blue excitation beam of the lighting module 100 is directly guided with the lighting beam LE′ from the light splitting element 160 to provide the blue light part of the lighting beam. Alternatively, a blue light source is additionally set to provide the blue light part of the lighting beam.

A conventional rotating wheel module requires a driver disposed hereon that is connected to the rotating wheel module in order to rotate, so it is difficult to reduce the size of the rotating wheel module, and due to the large volume of the driver and the large area of the connecting surface between the driver and the rotating wheel module, the optical elements on the rotating wheel module must avoid the zone of the driver, which affects the area where the optical elements can be disposed on the rotating wheel module. The first airflow 131 generated by the first airflow generator 130 of the lighting module 100 of this embodiment drives the driving blades 121 of the rotating wheel module 120 and drives the rotating wheel module 120 to rotate with the first passive rotating shaft 129 as the center. The rotating wheel module 120 of this embodiment does not require a driver, and only needs to drive the blades 121 and the first passive rotating shaft 129. Therefore, the size of the rotating wheel module 120 can be reduced, and the area on the rotating wheel module 120 where the optical element 123 can be disposed is no longer limited by a driver, in which the optical element 123 with a larger area can be disposed.

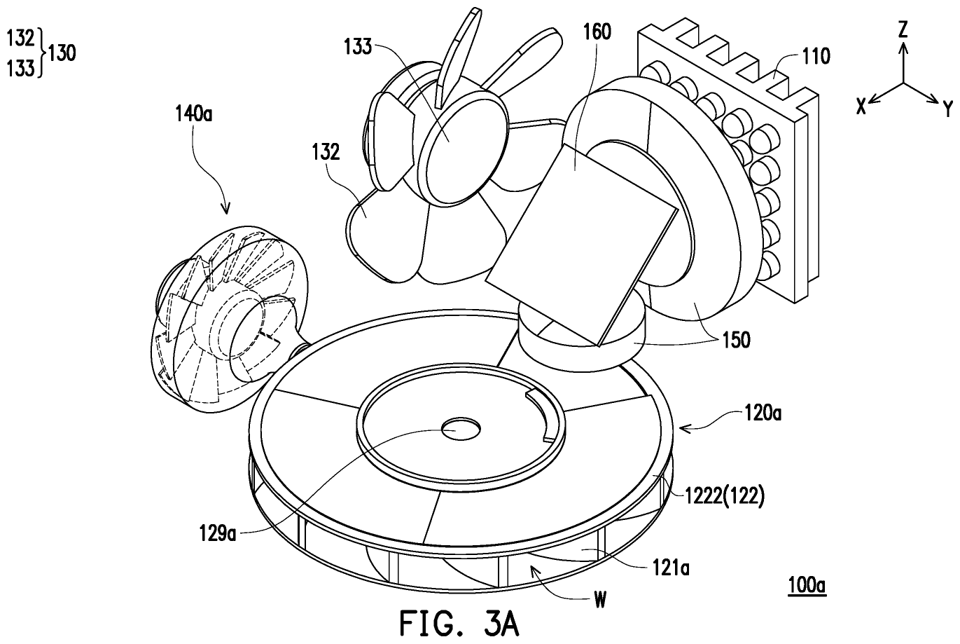

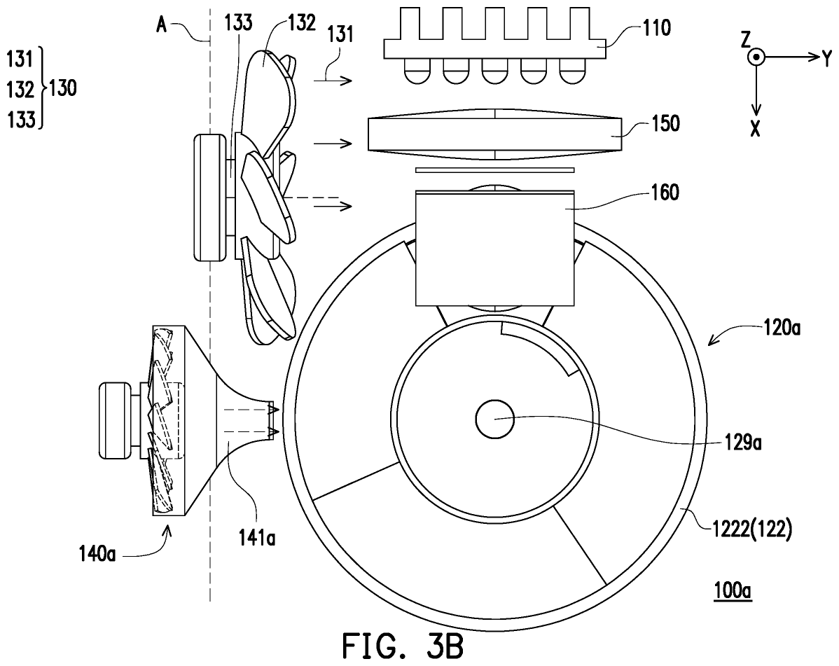

FIG. 3A is a schematic perspective view of the lighting module of the second embodiment. FIG. 3B is a top view of the lighting module of FIG. 3A. Referring to FIG. 2A and FIG. 3A, the lighting module 100a of this embodiment is similar to the lighting module 100 of FIG. 2A, in which the difference between the two modules is: the lighting module 100a of this embodiment further includes a second airflow generator 140a, disposed beside the rotating wheel module 120a. The second airflow generator 140a is used to generate a second airflow 141a (shown in FIG. 3B).

Referring to FIG. 3B, the orthographic projection of the second airflow generator 140a on the reference plane A at least partially overlaps the orthographic projection of the driving blade 121a (shown in FIG. 3A) of the rotating wheel module 120a on the reference plane A, and the orthographic projection of the second airflow generator 140a on the reference plane A and the orthographic projection of the light source 110 on the reference plane A do not overlap each other. In this embodiment, the second airflow 141a generated by the second airflow generator 140a mainly flows through the airflow channel W of the driving blades 121a of the rotating wheel module 120a to drive the rotating wheel module 120a to rotate with the first passive rotating shaft 129a as the center. The first airflow generator 130 can also drive the rotating wheel module 120a to rotate, and dissipate heat to lower the temperature of the light source 110.

In addition, since the second airflow 141a mainly flows to the rotating wheel module 120a, the cooling speed and the rotational speed of the rotating wheel module 120a in this embodiment can be faster.

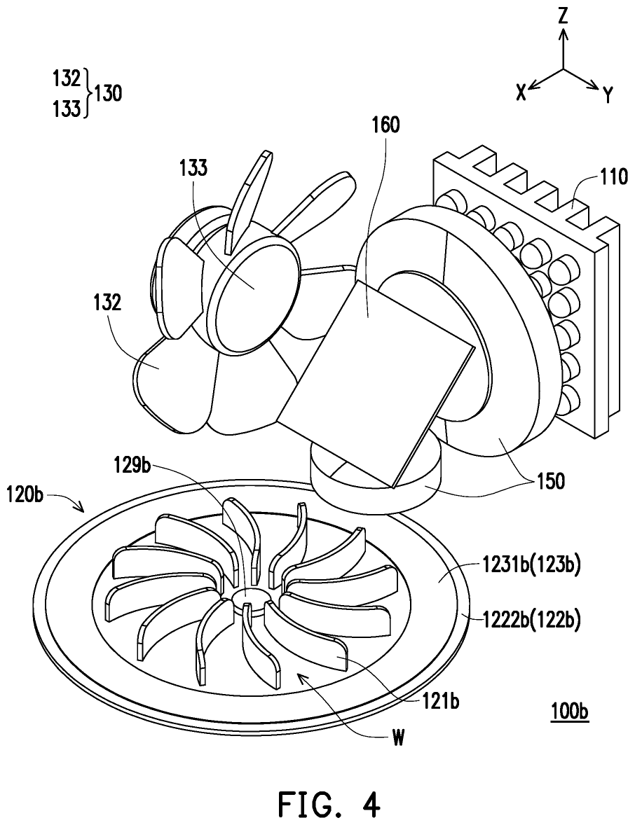

FIG. 4 is a schematic perspective view of a lighting module according to the third embodiment of the present invention. Referring to FIG. 2A and FIG. 4, the lighting module 100b of this embodiment is similar to the lighting module 100 of FIG. 2A, the difference between the two modules is: the driving blades 121b of the rotating wheel module 120b of this embodiment are exposed outside the rotating wheel module 120b, and has only one wavelength conversion layer 1231b.

In detail, the rotating wheel module 120b of this embodiment includes a base plate 122b, an optical element 123b disposed on the base plate 122b, and driving blades 121b, in which the base plate 122b includes a reflective metal layer 1222b. The optical element 123b is connected to the base plate 122b and disposed on the periphery of the driving blades 121b. That is, the driving blade 121b is disposed between the optical element 123b and the first passive rotating shaft 129b in the radial direction of the base plate 122b. The optical element 123b of this embodiment is, for example, the wavelength conversion layer 1231b.

Similarly, the first airflow 131 (as shown in FIG. 2B) generated by the first airflow generator 130 can dissipate heat and cool down the light source 110 and the rotating wheel module 120b, and at the same time drive the rotating wheel module 120b to rotate with the first passive rotating shaft 129b as the center.

In addition, since there is only one wavelength conversion layer 1231b in this embodiment, which is disposed on the base plate 122b in a complete ring shape, the color of the lighting beam LE′ is a specific color, and there is no timing synchronization issue during the rotation of the rotating wheel module 120b. Therefore, it is not necessary to consider the rotational speed control of the rotating wheel module 120b.

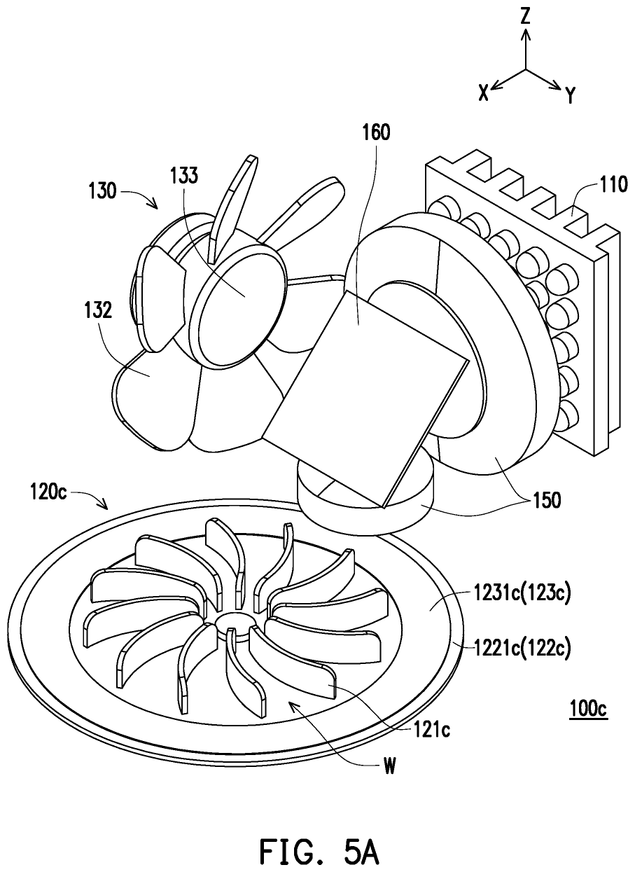

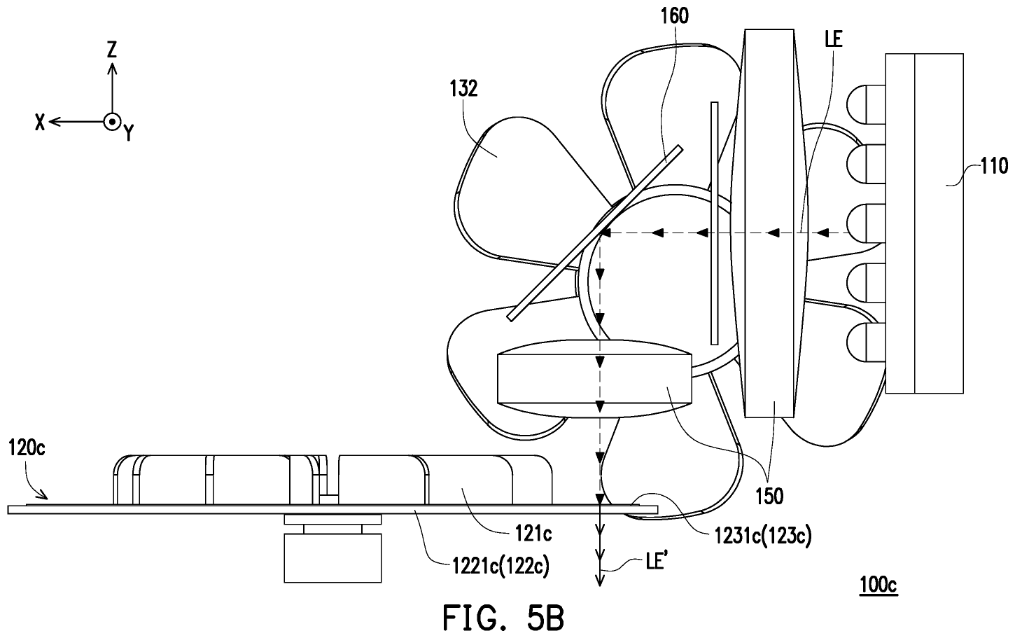

FIG. 5A is a schematic perspective view of a lighting module according to the fourth embodiment. FIG. 5B is a side view of the lighting module of FIG. 5A. Referring to FIG. 4 and FIG. 5A, the lighting module 100c of this embodiment is similar to the lighting module 100b of FIG. 4, and the difference between the two modules is: the rotating wheel module 120c of this embodiment is a transmissive wheel, and the base plate 122c is a light-transmitting base plate. The rotating wheel module 120c can be, for example, a phosphor wheel or a diffusion wheel. The optical element 123c can be, for example, a wavelength conversion layer 1231c or a light diffusing layer (not shown).

Referring to FIG. 5B, after the excitation beam LE provided by the light source 110 passes through the condensing lens 150, the excitation beam LE is reflected by the light splitting element 160 and passes through another condensing lens 150, and then enters the rotating wheel module 120c. In this embodiment, the rotating wheel module 120c is embodied as a transmissive phosphor wheel, the base plate 122c is a light-transmitting glass 1221c, and the optical element 123c disposed on the base plate 122c is the wavelength conversion layer 1231c. When the excitation beam LE enters the wavelength conversion layer 1231c of the rotating wheel module 120c and the base plate 122c (the material thereof is the light-transmitting glass 1221c), the lighting beam LE′ converted by the wavelength conversion layer 1231c passes through the base plate 122c and then is directed toward the light valve assembly 11. In addition, in other embodiments, the wavelength conversion layer 1231c disposed on the base plate 122c may not be annular, and when the excitation light LE enters the base plate 122c on which the wavelength conversion layer 1231c is not disposed on the rotating wheel module 120c, the excitation light LE can directly be transmitted to the light valve assembly 11 (shown in FIG. 1) to provide the blue light part of the lighting beam.

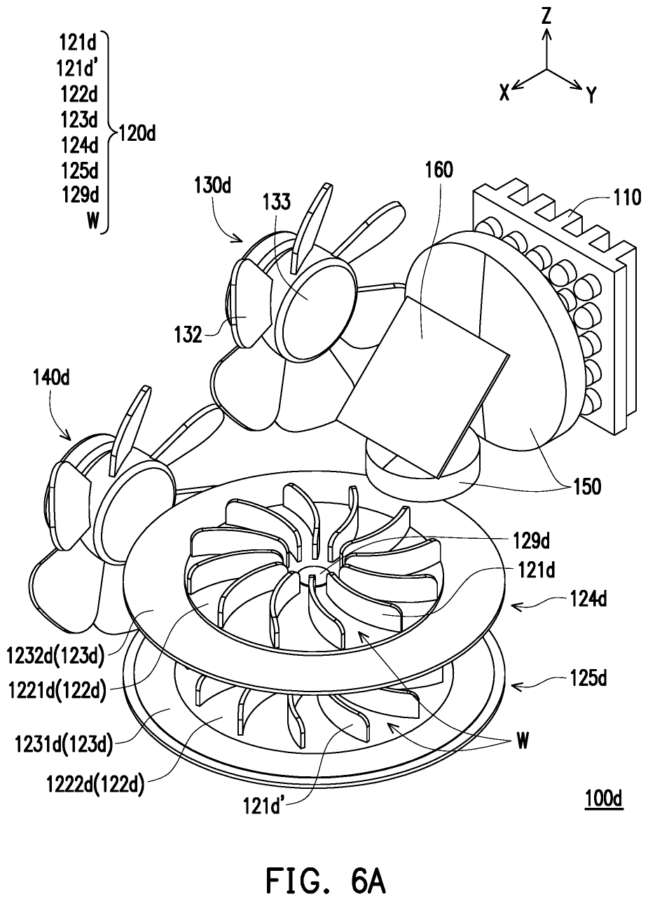

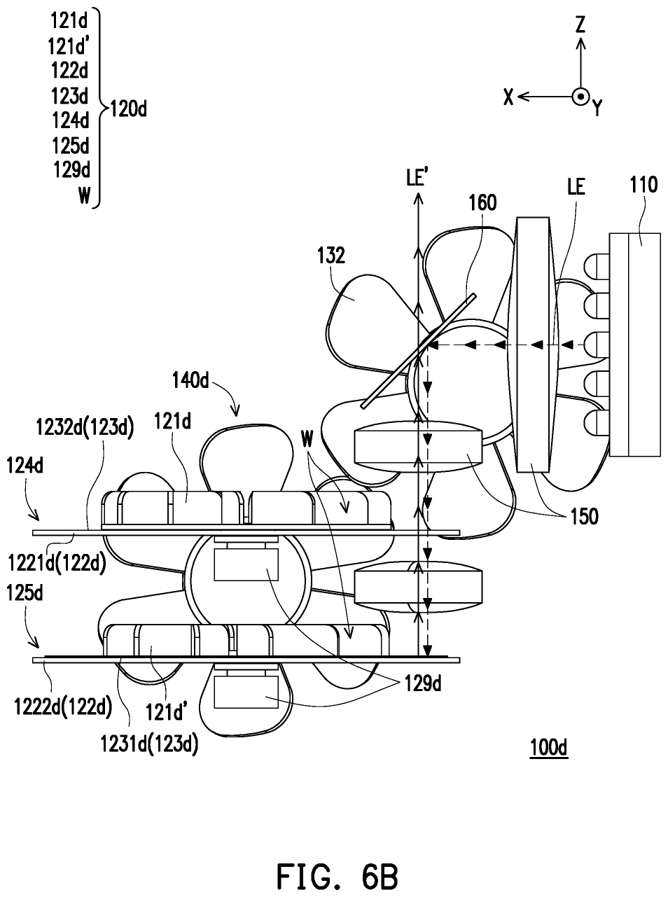

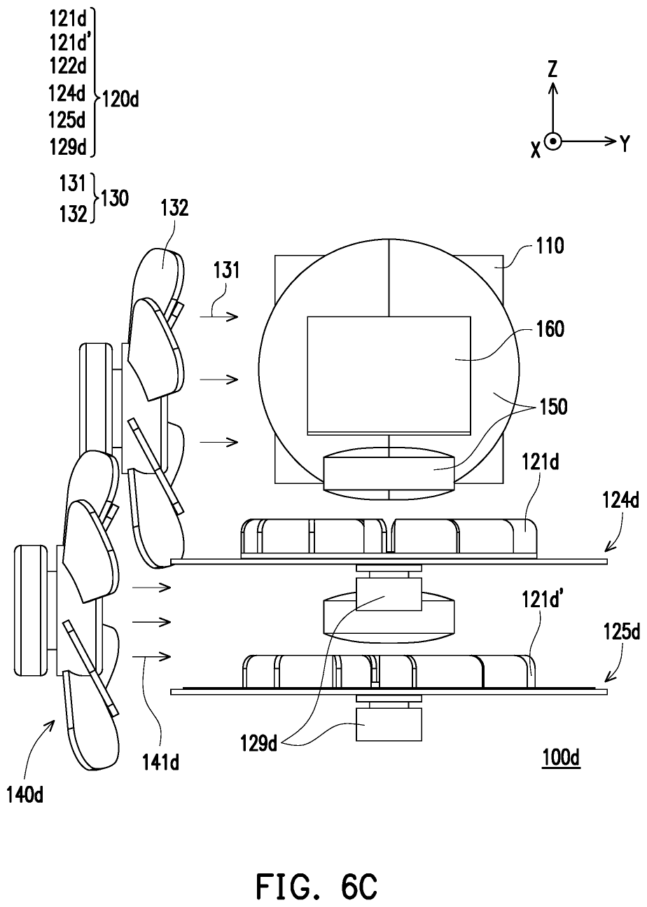

FIG. 6A is a schematic perspective view of a lighting module according to the fifth embodiment. FIG. 6B and FIG. 6C are side views of the lighting module of FIG. 6A. The lighting module 100d of this embodiment has two rotating wheels and two airflow generators. Referring to FIG. 5A and FIG. 6A, the lighting module 100d of this embodiment is similar to the lighting module 100c of FIG. 5, in which the difference between the two modules is: the lighting module 100d of this embodiment further includes a second rotating wheel 125d having driving blades 121d′, and a second airflow generator 140d. The first rotating wheel 124d and the second rotating wheel 125d can each be a diffusion wheel or a phosphor wheel. The base plate 122d of the first rotating wheel 124d can be, for example, a transmissive base plate, and the base plate 122d of the second rotating wheel 125d can be, for example, a transmissive or reflective base plate. In this embodiment, the first rotating wheel 124d and the second rotating wheel 125d are embodied as a diffusion wheel and a phosphor wheel, respectively.

In detail, referring to FIG. 6A to FIG. 6C, the rotating wheel module 120d of the present embodiment includes the first rotating wheel 124d and the second rotating wheel 125d which are separated from each other. The first rotating wheel 124d and the second rotating wheel 125d are coaxially disposed. That is, the first rotating wheel 124d and the second rotating wheel 125d are both connected to the first passive rotating shaft 129d. The driving blades 121d are disposed on the base plate 122d of the first rotating wheel 124d. The driving blades 121d′ are disposed on the base plate 122d of the second rotating wheel 125d.

The second airflow generator 140d generates the second airflow 141d (shown in FIG. 6C). The second airflow 141d flows through the airflow channel W (shown in FIG. 6A) between the driving blades 121d and 121d′, and can simultaneously drive the first rotating wheel 124d and the second rotating wheel 125d to rotate with the first passive rotating shaft 129d as the center. On the XZ plane, there is a reference plane (not shown, referring to the reference plane A shown in FIG. 2B) perpendicular to the first driving shaft 133, and the orthographic projections of the first rotating wheel 124d and the second rotating wheel 125d on the reference plane are at least partially overlapped with the orthographic projection of the second airflow generator 140d on the reference plane. The first airflow generator 130 can also drive the first rotating wheel 124d to rotate, and dissipate heat and cool down the light source 110. That is, the first rotating wheel 124d is simultaneously driven by the first airflow 131d and the second airflow 141d. Therefore, the cooling speed of the first rotating wheel 124d in this embodiment can be faster.

In this embodiment, specifically, the material of the first rotating wheel 124d is a light-transmitting glass 1221d, and the second rotating wheel 125d includes a reflective metal layer 1222d. In addition, the optical element 123d of the rotating wheel module 120d includes at least one wavelength conversion layer 1231d or a light diffusing layer 1232d. In this embodiment, specifically, the light diffusing layer 1232d is disposed on the first rotating wheel 124d, and the wavelength conversion layer 1231d is disposed on the second rotating wheel 125d. In other embodiments, the light diffusing layer 1232d includes, for example, diffusing substances or particles.

Referring to FIG. 6B, after the excitation beam LE provided by the light source 110 passes through the condensing lens 150, the excitation beam LE is reflected by the light splitting element 160. The excitation beam LE then passes through another condensing lens 150, and is then directed toward the first rotating wheel 124d. Since the material of the first rotating wheel 124d is the light-transmitting glass 1221d, the excitation beam LE can pass through the first rotating wheel 124d and be directed toward the second rotating wheel 125d.

Since the second wheel 125d includes the reflective metal layer 1222d, and the optical element 123d on the second rotating wheel 125d is the wavelength conversion layer 1231d, the wavelength of the excitation beam LE is changed by the wavelength conversion layer 1231d (that is, the color of the light beam is changed) and converted into the lighting beam LE′. The lighting beam LE′ is reflected by the reflective metal layer 1222d, and then passes through the first rotating wheel 124d and the light splitting element 160, and is transmitted to the light valve assembly 11 (shown in FIG. 1).

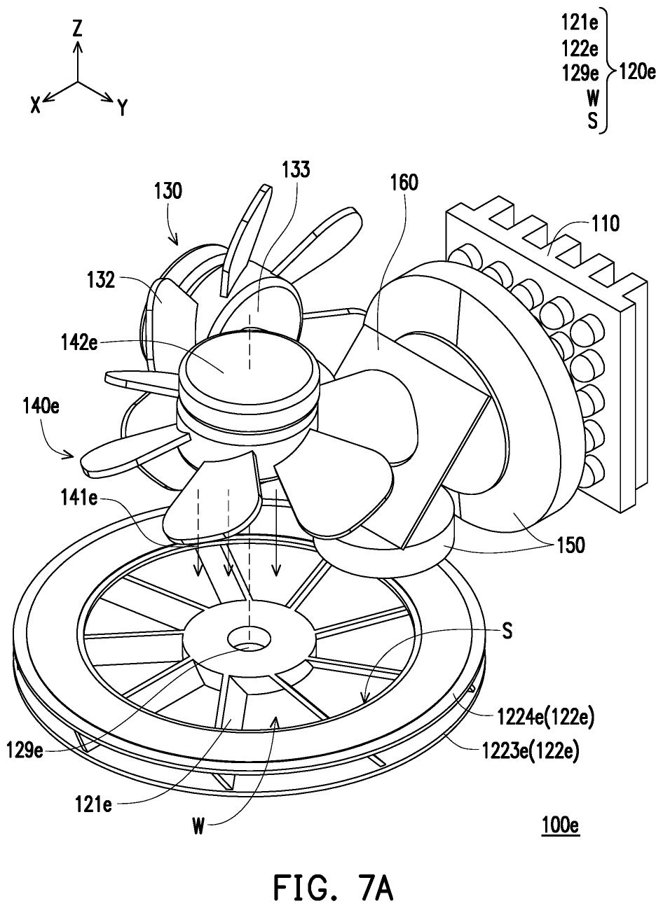

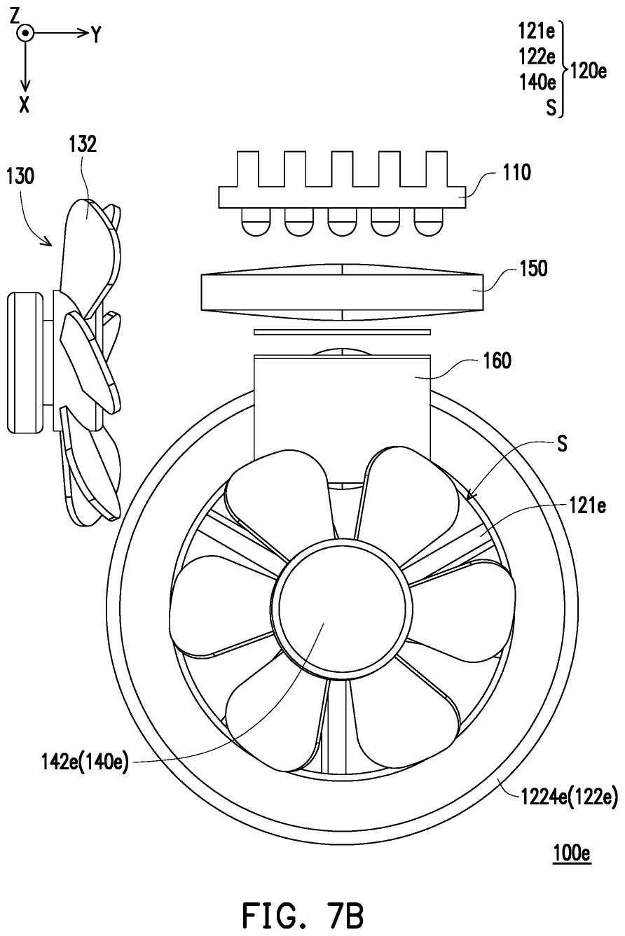

FIG. 7A is a schematic perspective view of a lighting module according to the sixth embodiment. FIG. 7B is a top view of the lighting module of FIG. 7A. Referring to FIG. 2A and FIG. 7A, the lighting module 100e of this embodiment is similar to the lighting module 100 of FIG. 2A, and the difference between the two modules is: the lighting module 100e of this embodiment further includes a second airflow generator 140e and at least one opening S disposed on the second disc body 1224e. In the axial direction of the Z-axis, the second airflow generator 140e is located above the first disc body 1223e and the second disc body 1224e and configured to generate the second airflow 141e. The at least one opening S located on the second disc body 1224e faces the second airflow generator 140e, and is configured to let the second airflow 141e pass through.

The first passive rotating shaft 129e of the base plate 122e in this embodiment is perpendicular to the first disc body 1223e and the second disc body 1224e. The second airflow generator 140e includes a second driving shaft 142e. The first passive rotating shaft 129e is parallel to the second driving shaft 142e. In this embodiment, specifically, the first passive rotating shaft 129e is coaxial with the second driving shaft 142e. Furthermore, the extended axes of the first driving shaft 133 and the second driving shaft 142e do not intersect in the space.

Referring to FIG. 7A, in this embodiment, the driving blades 121e are obliquely disposed between the first disc body 1223e and the second disc body 1224e. In the axial direction of the Z-axis, the second disc body 1224e is located between the first disc body 1223e and the second airflow generator 140e, and the second disc body 1224e includes at least one opening S connecting the airflow channel W.

In this embodiment, the opening S of the second disc body 1224e is disposed adjacent to the center of the second disc body 1224e, that is, adjacent to the first passive rotating shaft 129e (shown in FIG. 7A), but the position of the opening S is not limited thereto. The second airflow 141e enters the airflow channel W of the rotating wheel module 120e from the opening S and drives the driving blades 121e, which drive the coaxial first disc body 1223e and second disc body 1224e to rotate.

Specifically, as shown in FIG. 7A and FIG. 7B, in the axial direction of the Z-axis, the second airflow generator 140e is located above the opening S of the second disc body 1224e. That is, the second airflow 141e (shown in FIG. 7A) generated by the second airflow generator 140e flows vertically toward the opening S of the second disc body 1224e. The second airflow 141e passes through the opening S and then flows through the airflow channel W (shown in FIG. 7A) between the driving blades 121e, thereby driving the first disc body 1223e and the second disc body 1224e to rotate.

In addition, there is a reference plane perpendicular to the first driving shaft 133 on the XZ plane (not shown, referring to the reference plane A shown in FIG. 2B), and the orthographic projection of the rotating wheel module 120e and the light source 110 on the reference plane at least partially overlaps the orthographic projection of the first airflow generator 130 on the reference plane. That is, the first airflow generator 130 in this embodiment can dissipate heat from the light source 110 and the rotating wheel module 120e at the same time, while the second airflow generator 141e mainly dissipates heat from the rotating wheel module 120e.

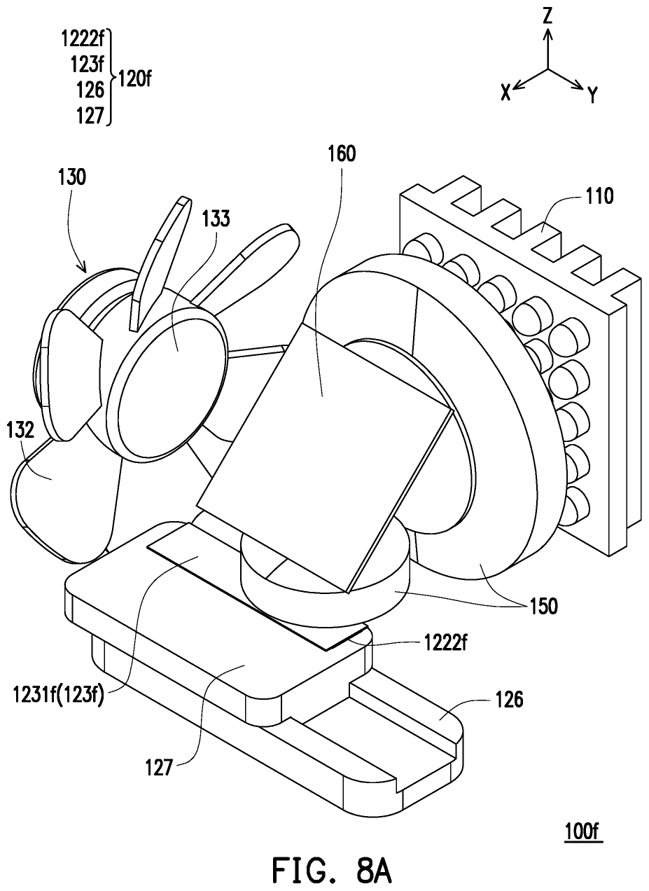

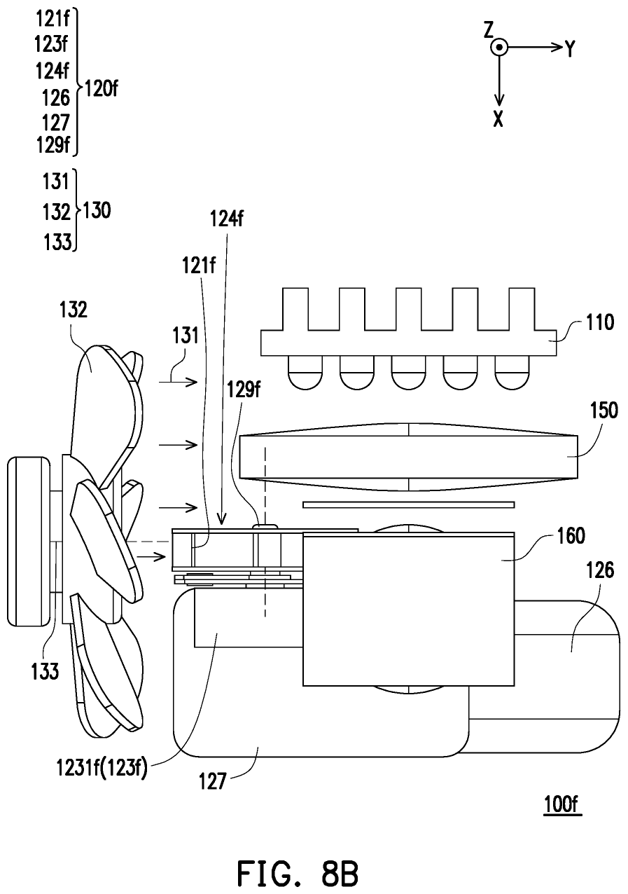

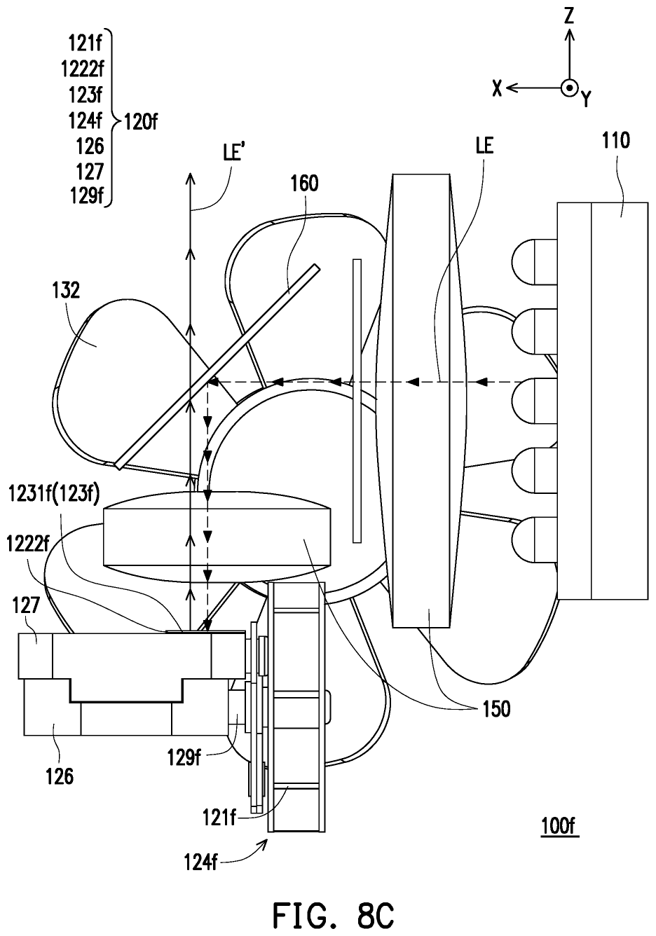

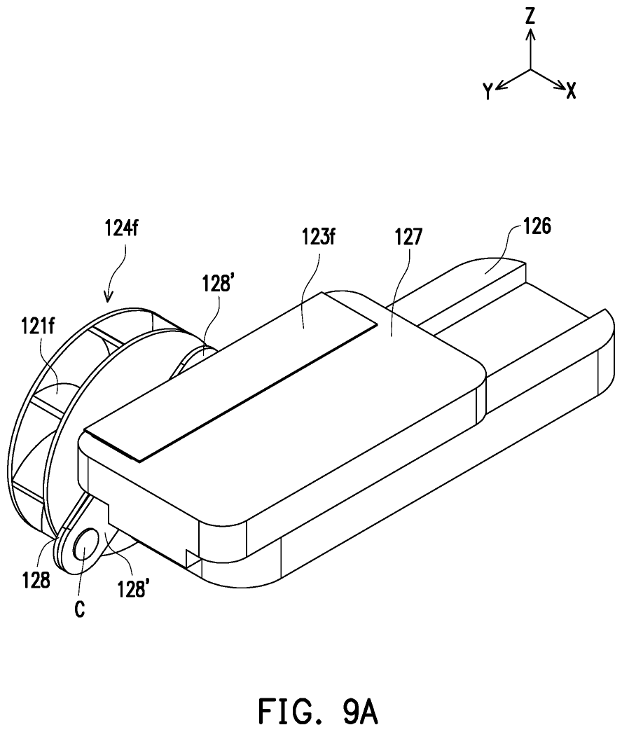

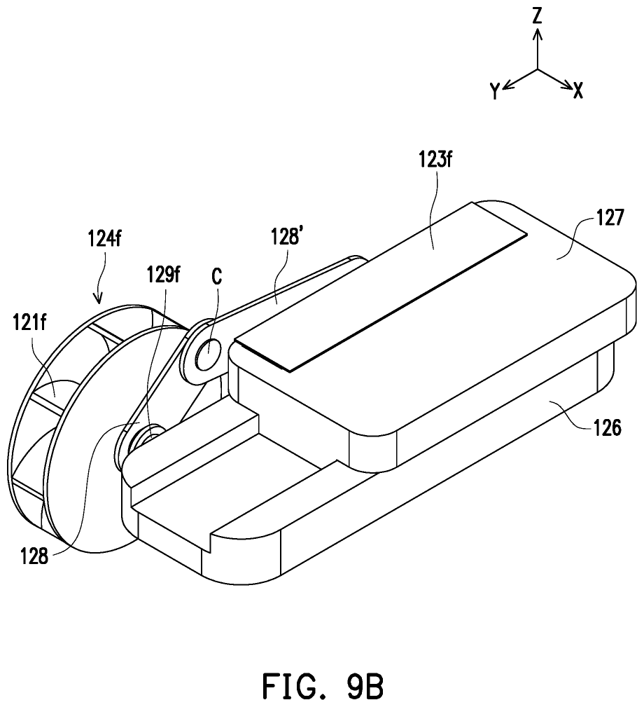

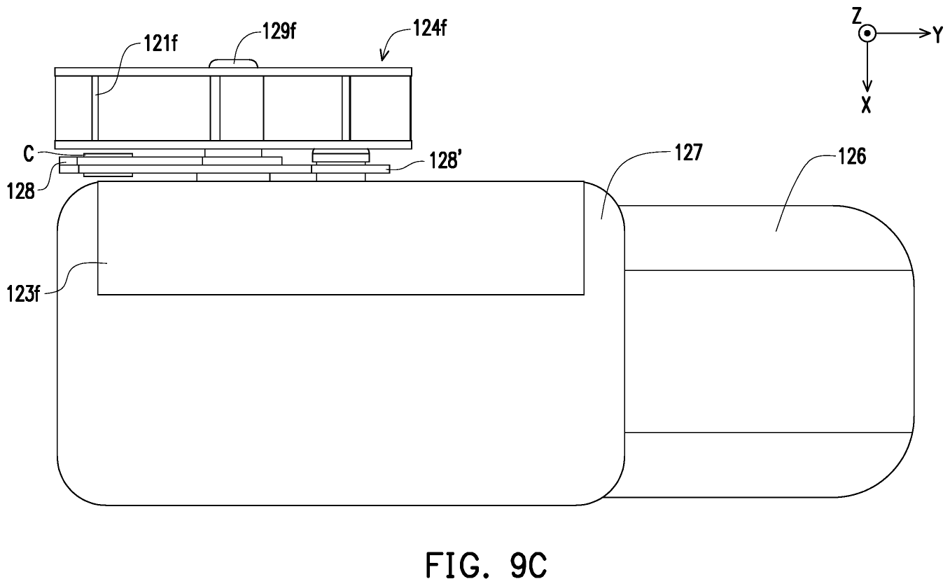

FIG. 8A is a schematic perspective view of a lighting module according to the seventh embodiment. FIG. 8B and FIG. 8C are a top view and a side view of the lighting module of FIG. 8A, respectively. FIG. 9A and FIG. 9B are schematic views of a slide rail, a sliding block, and a first rotating wheel shown in FIG. 8A in different states. FIG. 9C is a top view of the slide rail, the sliding block, and the first rotating wheel of FIG. 9A and FIG. 9B.

Referring to FIG. 8A to FIG. 8C, the rotating wheel module 120f of this embodiment includes a first rotating wheel 124f (shown in FIG. 8B and FIG. 8C), a slide rail 126, and a sliding block 127 slidably disposed on the slide rail 126. The first rotating wheel 124f includes a first passive rotating shaft 129f (shown in FIG. 8B) pivotally connected to the slide rail 126. The extension direction of the slide rail 126 is parallel to the first driving shaft 133 (shown in FIG. 8B). The sliding block 127 includes an optical element 123f.

In this embodiment, as shown in FIG. 8B, the first driving shaft 133 of the first airflow generator 130 is perpendicular to the first passive rotating shaft 129f. On the XZ plane, there is a reference plane perpendicular to the first driving shaft 133 (not shown, referring to the reference plane A shown in FIG. 2B) and the orthographic projection of the first rotating wheel 124f on the reference plane where the first airflow generator 130 is located at least partially overlaps the orthographic projection of the first airflow generator 130 on the reference plane. The driving blades 121f are, for example, disposed on the base plate (not numbered) of the first rotating wheel 124f and spaced apart from each other. Therefore, when the first airflow 131 (shown in FIG. 8B) generated by the first airflow generator 130 flows toward the first rotating wheel 124f, the first airflow 131 drives the driving blades 121f disposed on the first rotating wheel 124f, thereby driving the first rotating wheel 124f to rotate with the first passive rotating shaft 129f as the center.

Referring to FIG. 9A to FIG. 9C, the rotating wheel module 120f further includes connecting rods 128 and 128′. The connecting rod 128 is pivotally connected to the first passive rotating shaft 129f (shown in FIG. 9B) and the connecting rod 128′, and the connecting rod 128′ is pivotally connected to the connecting rod 128 and the sliding block 127. As shown in FIG. 9B, the two ends of the connecting rod 128 are pivotally connected to the first passive rotating shaft 129f and one end of the connecting rod 128′, respectively, and the other end of the connecting rod 128′ is pivotally connected to the sliding block 127.

When the first rotating wheel 124f rotates, the connecting rod 128 moves along with the first rotating wheel 124f and rotates with the first passive rotating shaft 129f as the axis. One end of the connecting rod 128′ is pivotally connected to the connecting rod 128 at the connection point C, and is driven by the rotation of the connecting rod 128.

When the first rotating wheel 124f and the connecting rod 128 rotate half a turn, such as changing from the state of FIG. 9A to the state of FIG. 9B, the connecting rod 128′ thereby drives the sliding block 127 having the optical element 123f to move along the slide rail 126 in a negative Y axis direction, and slides from one end to the other end of the slide rail 126. When the first rotating wheel 124f and the connecting rod 128 rotate another half turn, the sliding block 127 moves in the Y axis direction along the slide rail 126 through the connecting rod 128′, and returns to the initial position (that is, changing from the state of FIG. 9B back to the state of FIG. 9A).

Therefore, in the process that the first airflow 131 drives the driving blades 121f to rotate the first rotating wheel 124f, the sliding block 127 slides back and forth relative to the slide rail 126.

Returning to FIG. 8C, after the excitation beam LE provided by the light source 110 passes through the condensing lens 150, the excitation beam LE is reflected by the light splitting element 160 and then passes through another condensing lens 150, and enters the optical element 123f disposed on the sliding block 127. Specifically, the sliding block 127 of this embodiment includes a reflective metal layer 1222f thereon, and the optical element 123f is, for example, a wavelength conversion layer 1231f and disposed above the reflective metal layer 1222f. Therefore, the wavelength of the excitation beam LE is changed by the wavelength conversion layer 1231f and converted into a lighting beam LE′, and the lighting beam LE′ is reflected by the reflective metal layer 1222f back to the light splitting element 160, then passes through the light splitting element 160, and is transmitted to the light valve assembly 11 (shown in FIG. 1). In other embodiments, the shape of the optical element 123f is, for example, a circle, a square, a rectangle, etc., but the present invention is not limited thereto.

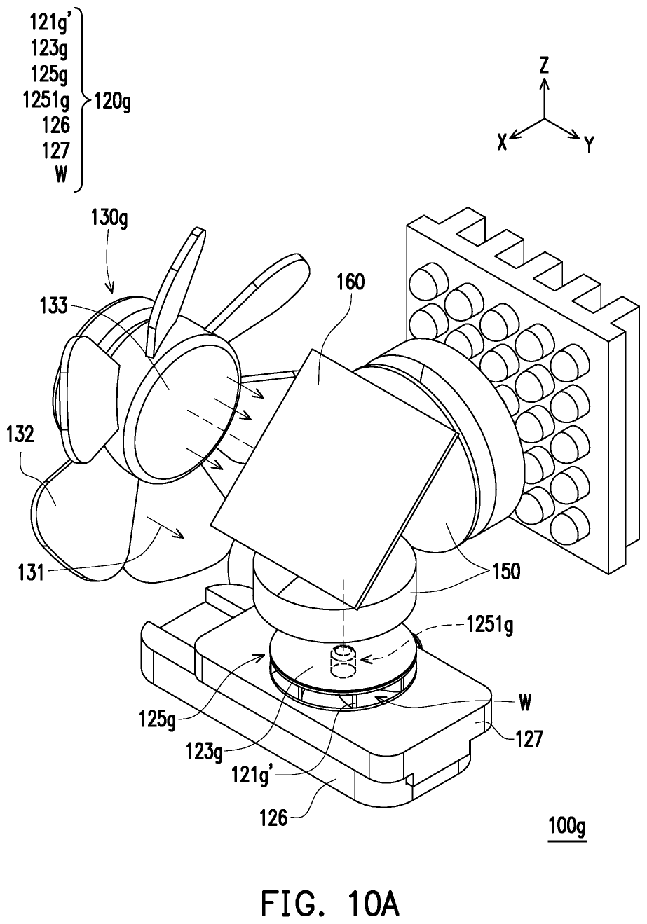

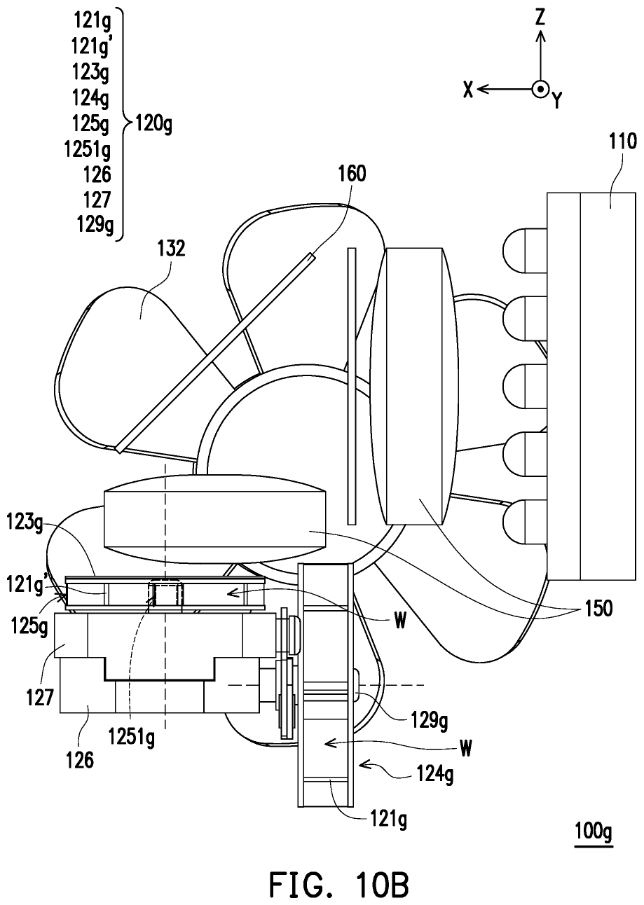

FIG. 10A is a schematic perspective view of a lighting module according to the eighth embodiment. FIG. 10B is a side view of the lighting module of FIG. 10A. Referring to FIG. 8A and FIG. 10A, the lighting module 100g of this embodiment is similar to the lighting module 100f of FIG. 8A, and the difference between the two modules is: the rotating wheel module 100g of this embodiment further includes a second rotating wheel 125g, and the second rotating wheel 125g includes an optical element 123g and driving blades 121g′.

In detail, referring to FIG. 10A and FIG. 10B, the second rotating wheel 125g includes a second passive rotating shaft 1251g, and the second passive rotating shaft 1251g is pivotally connected to the sliding block 127. The second passive rotating shaft 1251g is perpendicular to the first passive rotating shaft 129g (shown in FIG. 10B), and the second passive rotating shaft 1251g is perpendicular to the first driving shaft 133 (shown in FIG. 10A).

That is, when the first airflow generator 130 generates the first airflow 131 (shown in FIG. 10A), the first airflow 131 drives the driving blades 121g (shown in FIG. 10A) of the first rotating wheel 124g and the driving blades 121g′ of the second rotating wheel 125g, which further drive the first rotating wheel 124g (shown in FIG. 10A) and the second rotating wheel 125g to rotate, respectively.

As shown in FIG. 9A to FIG. 9B, when the first rotating wheel 124g rotates, the sliding block 127 slides back and forth on the Y-axis relative to the slide rail 126. In addition, in this embodiment, the second rotating wheel 125g disposed on the sliding block 127 not only slides back and forth together with the sliding block 127, but also rotates simultaneously on the XY plane with the second passive rotating shaft 1251g as the rotation center, so that the optical element 123g disposed on the second rotating wheel 125g presents an irregular path.

To sum up, the embodiments of the present invention have at least one of the following advantages or effects. The first airflow generated by the first airflow generator of the rotating wheel module of the lighting module of the present invention flows through the airflow channel and drives the driving blades, which drive the rotating wheel module to rotate. With the foregoing design, the rotating wheel module of the present invention can be passively rotated by the first airflow, and a driver is not needed to rotate the rotating wheel module. Since the driver originally disposed on the rotating wheel module is omitted from the lighting module, the lighting module of the present invention has a smaller size and greater design flexibility. In addition, the rotating wheel module also has a larger usable area.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby enabling persons skilled in the art in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A lighting module, configured to provide a lighting beam, comprising:
a light source, configured to provide an excitation beam;
a rotating wheel module, disposed on a transmission path of the excitation beam, wherein the rotating wheel module comprises a plurality of driving blades, and the driving blades are disposed at an interval and any two adjacent driving blades form an airflow channel; and
a first airflow generator, configured to generate a first airflow, wherein the first airflow flows through the airflow channels of the driving blades to drive the rotating wheel module to rotate, and at least a part of the light source is disposed on a flow path of the first airflow.

2. The lighting module according to claim 1, wherein the first airflow generator is a fan, and comprises a plurality of first fan blades and a first driving shaft, wherein an orthographic projection of the driving blades of the rotating wheel module on a reference plane perpendicular to the first driving shaft at least partially overlaps an orthographic projection of the first fan blades on the reference plane.

3. The lighting module according to claim 2, wherein an orthographic projection of the light source on the reference plane of the first airflow generator at least partially overlaps the orthographic projection of the first fan blades on the reference plane.

4. The lighting module according to claim 1, further comprising a second airflow generator configured to generate a second airflow, wherein the second airflow flows through the airflow channels of the driving blades to drive the rotating wheel module to rotate.

5. The lighting module according to claim 4, wherein the rotating wheel module further comprises a first rotating wheel and a second rotating wheel, and the driving blades are disposed on the first rotating wheel and the second rotating wheel.

6. The lighting module according to claim 1, wherein the rotating wheel module further comprises a base plate, the base plate comprises a first disc body and a second disc body, the first disc body is coaxial with the second disc body and spaced apart from the second disc body, and the driving blades are located between the first disc body and the second disc body.

7. The lighting module according to claim 1, wherein the rotating wheel module further comprises a first passive rotating shaft, and the first airflow generator comprises a first driving shaft, and the first passive rotating shaft is perpendicular to the first driving shaft, wherein the rotating wheel module is not connected to the first airflow generator.

8. The lighting module according to claim 1, wherein the rotating wheel module further comprises a base plate and an optical element connected to the base plate.

9. The lighting module according to claim 8, wherein the base plate comprises a light-transmitting glass or a reflective metal layer.

10. The lighting module according to claim 8, wherein the optical element comprises at least one wavelength conversion layer or a light diffusing layer.

11. The lighting module according to claim 8, wherein the driving blades are disposed on the base plate.

12. The lighting module according to claim 8, further comprising a second airflow generator configured to generate a second airflow, wherein the base plate further comprises a first disc body and a first passive rotating shaft, and the second airflow generator comprises a second driving shaft, wherein the driving blades are obliquely disposed on the first disc body, the first passive rotating shaft is perpendicular to the first disc body, and the first passive rotating shaft is parallel to the second driving shaft.

13. The lighting module according to claim 12, wherein the base plate further comprises a second disc body coaxial with the first disc body and spaced apart from the first disc body, the second disc body is disposed between the first disc body and the second airflow generator, the driving blades are located between the first disc body and the second disc body, the second disc body comprises at least one opening, the at least one opening connects the airflow channels, and the second airflow enters the airflow channels of the rotating wheel module from the at least one opening and drives the driving blades.

14. The lighting module according to claim 1, wherein the rotating wheel module comprises a first rotating wheel, a slide rail, and a sliding block slidably disposed on the slide rail, wherein the first rotating wheel comprises a first passive rotating shaft, the driving blades are disposed on the first rotating wheel, the first passive rotating shaft is pivotally connected to the slide rail, the first airflow generator comprises a first driving shaft, the first driving shaft is perpendicular to the first passive rotating shaft, and an extension direction of the slide rail is parallel to the first driving shaft.

15. The lighting module according to claim 14, wherein the sliding block comprises an optical element.

16. The lighting module according to claim 14, wherein the rotating wheel module further comprises a second rotating wheel, the second rotating wheel comprises a second passive rotating shaft, the second passive rotating shaft is pivotally connected to the sliding block, the second passive rotating shaft is perpendicular to the first passive rotating shaft and perpendicular to the first driving shaft, and the second rotating wheel comprises an optical element.

17. A projection device, comprising:
a lighting module, configured to provide a lighting beam, comprising:
a light source, configured to provide an excitation beam;
a rotating wheel module, disposed on a transmission path of the excitation beam, wherein the rotating wheel module comprises a plurality of driving blades, the driving blades are disposed at an interval and any two adjacent driving blades form an airflow channel, and the lighting beam comprises the excitation beam; and
a first airflow generator, disposed beside the rotating wheel module and configured to generate a first airflow, wherein the first airflow flows through the airflow channels of the driving blades to drive the rotating wheel module to rotate, and at least a part of the light source is disposed on a flow path of the first airflow;
a light valve assembly, disposed on a transmission path of the lighting beam, and configured to convert the lighting beam into an image beam; and
a projection lens, configured to project the image beam out of the projection device.

18. The projection device according to claim 17, wherein the first airflow generator is a fan, and comprises a plurality of first fan blades and a first driving shaft, wherein an orthographic projection of the driving blades of the rotating wheel module on a reference plane perpendicular to the first driving shaft at least partially overlaps an orthographic projection of the first fan blades on the reference plane.

19. The projection device according to claim 18, wherein an orthographic projection of the light source on the reference plane of the first airflow generator at least partially overlaps an orthographic projection of the first fan blades on the reference plane.

20. The projection device according to claim 17, further comprising a second airflow generator configured to generate a second airflow, wherein the second airflow flows through the airflow channels of the driving blades to drive the rotating wheel module to rotate.

21. The projection device according to claim 20, wherein the rotating wheel module further comprises a first rotating wheel and a second rotating wheel, and the driving blades are disposed on the first rotating wheel and the second rotating wheel.

22. The projection device according to claim 17, wherein the rotating wheel module further comprises a base plate, the base plate comprises a first disc body and a second disc body, the first disc body is coaxial with the second disc body and spaced apart from the second disc body, and the driving blades are located between the first disc body and the second disc body.

23. The projection device according to claim 17, wherein the rotating wheel module further comprises a first passive rotating shaft, and the first airflow generator comprises a first driving shaft, and the first passive rotating shaft is perpendicular to the first driving shaft, wherein the rotating wheel module is not connected to the first airflow generator.

24. The projection device according to claim 17, wherein the rotating wheel module further comprises a base plate and an optical element connected to the base plate.

25. The projection device according to claim 24, wherein the base plate comprises a light-transmitting glass or a reflective metal layer.

26. The projection device according to claim 24, wherein the optical element comprises at least one wavelength conversion layer or a light diffusing layer.

27. The projection device according to claim 24, wherein the driving blades are disposed on the base plate.

28. The projection device according to claim 24, further comprising a second airflow generator configured to generate a second airflow, wherein the base plate further comprises a first disc body and a first passive rotating shaft, the second airflow generator comprises a second driving shaft, the driving blades are obliquely disposed on the first disc body, the first passive rotating shaft is perpendicular to the first disc body, and the first passive rotating shaft is parallel to the second driving shaft.

29. The projection device according to claim 28, wherein the base plate further comprises a second disc body coaxial with the first disc body and spaced apart from the first disc body, the second disc body is disposed between the first disc body and the second airflow generator, the driving blades are located between the first disc body and the second disc body, the second disc body comprises at least one opening, the at least one opening connects the airflow channels, and the second airflow enters the airflow channels of the rotating wheel module from the at least one opening and drives the driving blades.

30. The projection device according to claim 17, wherein the rotating wheel module comprises a first rotating wheel, a slide rail, and a sliding block slidably disposed on the slide rail, wherein the first rotating wheel comprises a first passive rotating shaft, the driving blades are disposed on the first rotating wheel, the first passive rotating shaft is pivotally connected to the slide rail, the first airflow generator comprises a first driving shaft, the first driving shaft is perpendicular to the first passive rotating shaft, and an extension direction of the slide rail is parallel to the first driving shaft.

31. The projection device according to claim 30, wherein the sliding block comprises an optical element.

32. The projection device according to claim 30, wherein the rotating wheel module further comprises a second rotating wheel, the second rotating wheel comprises a second passive rotating shaft, the second passive rotating shaft is pivotally connected to the slide rail, the second passive rotating shaft is perpendicular to the first passive rotating shaft and perpendicular to the first driving shaft, and the second rotating wheel comprises an optical element.
